(19) United States
(12) Patent Application Publication
(10) Pub. No.: US 2014/0085943 A1
(43) Pub. Date: Mar. 27, 2014

(54) Controller with Quasi-Resonant Mode and Continuous Conduction Mode and Operating Method Thereof

(71) Applicant: PHIHONG TECHNOLOGY CO., LTD., Taoyuan County (TW)

(72) Inventors: Chung-Ming Lin, Taoyuan County (TW); Po-Ching Yu, Taoyuan County (TW); Wei-Chun Chang, Taoyuan County (TW)

(73) Assignee: PHIHONG TECHNOLOGY CO., LTD., Taoyuan County (TW)

(21) Appl. No.: 13/724,642

(22) Filed: Dec. 21, 2012

(30) Foreign Application Priority Data
Sep. 26, 2012 (TW) 101135410

(51) Int. Cl. H02M 3/335

(52) U.S. Cl. CPC H02M 3/33507
USPC 363/21.17

(57) ABSTRACT

The present invention relates to a controller with quasi-resonant mode and continuous conduction mode and an operating method thereof. The controller comprises: a transformer, a switching unit, a load-detecting unit and a controlling unit, and the transformer has a first winding and a secondary winding. The secondary winding connects to a load in parallel, and the switching unit electrically couples to the first winding. The load-detecting unit electrically couples to the switching unit for detecting status of the load. The controlling unit electrically couples between the switching unit and the load-detecting unit for switching operating modes between a quasi-resonant mode and a continuous conduction mode based on the status of the load.

The current application claims a foreign priority to the patent application of Taiwan No. 101135410 filed on Sep. 26, 2012.

### BACKGROUND

1. Field of Invention

The present invention relates to a controller and an operating method thereof, more particularly, the present invention relates to a controller with quasi-resonant mode and continuous conduction mode, and the controller switches its operating mode between the quasi-resonant mode and continuous conduction mode based on the level of loads.

2. Description of Related Art

With rapid developments of technology, electronic devices are generally applied to the life of human. However, the problem that associates with the energy shortage become serious day by day. Thus, people are now to focus on an important issue of improving the usage efficiency of energy.

Flyback converter has several advantages, such as low-cost, simply circuit frames, multiple outputs. Thus, flyback converter is usually utilized to auxiliary power design for applying power requirement of an entire system.

The circuit frame of flyback converter is constructed as a boost-buck converter circuit with isolating characteristic. Further, the flyback converter uses magnetic elements to generate magnetic inductance for storing and releasing the magnetic energy to match with the energy conversion.

The operating method of the traditional controller applying to the flyback converter is switched between continuous conduction mode (CCM) and discontinuous conduction mode (DCM) by a switching element (such as transistor element). For example, the foregoing switching method utilizes hard switching method to switch the operating modes, such as by using the so called pulse width modulation (PWM) controlling technique. Using these kinds of switching method to switch the operating modes, the controller will induce some problems, for example, the power switcher (such as transistor element) of the flyback converter will generate parasitic element. Further, the transformer will generate parasitic inductance as well. Those phenomenons will cause transient voltage or current with not zero value when the power switcher is instructed to switch the operating modes. A great mount of noise will be also generated by the status.

Therefore, the quasi-resonant flyback convertor with soft-switching method is developed. The soft-switching method is utilized to reduce the energy loss of switching and limit productions of the surge current. When the semiconductor switching device is used to conduct or cut-off in a short period, the soft-switching method will reduce the current passing the switching device or the voltages of the two ends of the switching device. Therefore, comparing with the CCM and DCM switching method of the controller applying the traditional flyback converter, the switching method of the quasi-resonant flyback converter will reduce the energy loss of switching for raising efficiency and will reduce the temperature of the devices. However, the performance of the transformer has limitation in the quasi-resonant flyback converter. Furthermore, the volume of the transformer is still huge to the current electronic devices.

### SUMMARY

The present invention provides a controller with quasi-resonant mode and continuous conduction mode. When a load is between no load and a typical load, the controller operates in the quasi-resonant mode; and when a load is between the typical load and a maximum load, the controller operates in the continuous conduction mode. The foregoing operating method of the controller will increase the performance of the transformer of the controller, and the volume of the transformer will become smaller effectively.

Therefore, the object of the present invention is to increase the performance of the transformer of the controller, and reduce the volume of the transformer effectively.

In order to approach the foregoing object, the present invention provides a controller with quasi-resonant mode and continuous conduction mode, which comprises: a transformer, a switching unit, a load-detecting unit and a controlling unit. The transformer has a first winding and a secondary winding. The secondary winding connects to a load in parallel, and the switching unit electrically coupled to the first winding. The load-detecting unit electrically couples to the switching unit for detecting status of the load. The controlling unit electrically couples between the switching unit and the load-detecting unit, and is utilized for switching operating modes between a quasi-resonant mode and a continuous conduction mode based on the status of the load.

Otherwise, the present invention also provides an operating method of a controller with quasi-resonant mode and continuous conduction mode. The steps of the operating method comprises: detecting a status of a load connects to said controller; and switching operating modes of the controller between a quasi-resonant mode and a continuous conduction mode based on the status of the load.

In certain embodiments of the present invention, the switching unit is filed-effect transistor, especially, the switching unit is metal-oxide-semiconductor field-effect transistor (MOSFET).

In certain embodiments of the present invention, the controlling unit is integrated circuit (IC) chip.

In certain embodiments of the present invention, the controller is applied to a flyback converter.

In certain embodiments of the present invention, the detected status of the load is current, and the load-detecting unit further comprises: a resistor and a current-detecting circuit. The resistor connects to the switching unit in series. One end of the current-detecting circuit is connected between the resistor and the switching unit, and another end is connected to the controlling unit. In other embodiments of the present invention, the detected status of the load is power, and the load-detecting unit is a power-detecting circuit. One end of the power-detecting circuit is connected to the switching unit, and another end is connected to the controlling unit.

In certain embodiment of the present invention, the controller operates in quasi-resonant mode when the status of the load is between no load and a typical load; and the controller operates in continuous conduction mode when the status of the load is between the typical load and a maximum load. In the case, the quasi-resonant mode is operated by both changing duty cycle and frequency; and the continuous conduction mode is operated by changing duty cycle and fixing frequency.

Moreover, in certain embodiment of the present invention, the controller with quasi-resonant mode and continuous conduction mode further comprises: a zero crossing detection circuit, which is connected to the controlling unit. Therefore, in quasi-resonant mode, the switching loss between the cut-off and conduct will be reduced.

As mentioned-above, the present invention discloses the controller with quasi-resonant mode and continuous conduction mode and an operating method thereof. The controller has the both capability of the quasi-resonant mode and the continuous conduction mode. Further, the controller switches the operating modes between the quasi-resonant mode and the continuous conduction mode for raising the performance of the transformer in the continuous conduction mode, and for reducing the loss of switching between cut-off and conduct by the switching unit in the quasi-resonant mode.

### BRIEF DESCRIPTION OF THE DRAWINGS

The present description will be better understood from the following detailed description read in light of the accompanying drawings, wherein:

FIG. 1 illustrates a schematic diagram illustrating an embodiment of a controller with quasi-resonant mode and continuous conduction mode according to the present invention;

FIG. 2 illustrates a flow chart of a method for operating method combining with quasi-resonant mode and continuous conduction mode according to the present invention;

FIG. 3 illustrates a schematic diagram illustrating another embodiment of a controller with quasi-resonant mode and continuous conduction mode according to the present invention; and

FIG. 4 illustrates a schematic diagram illustrating still another embodiment of a controller with quasi-resonant mode and continuous conduction mode according to the present invention.

### DETAILED DESCRIPTION

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

The main aspect of the present invention is to combine quasi-resonant mode and continuous conduction mode in a controller and operating method thereof. The controller is operated by one of the two modes based on the level of a load. When the load is defined as respective light load, the controller operates in the quasi-resonant mode; and when the load is determined as respective heavy load, the controller operates in the continuous conduction mode. Thus, the defects of the two modes are eliminated, and the advantages of the two modes are hold.

More particularly, the advantage is that the controller with quasi-resonant mode and continuous conduction mode would raise the performance of the inside transformer, and the volume of the transformer would be reduced effectively.

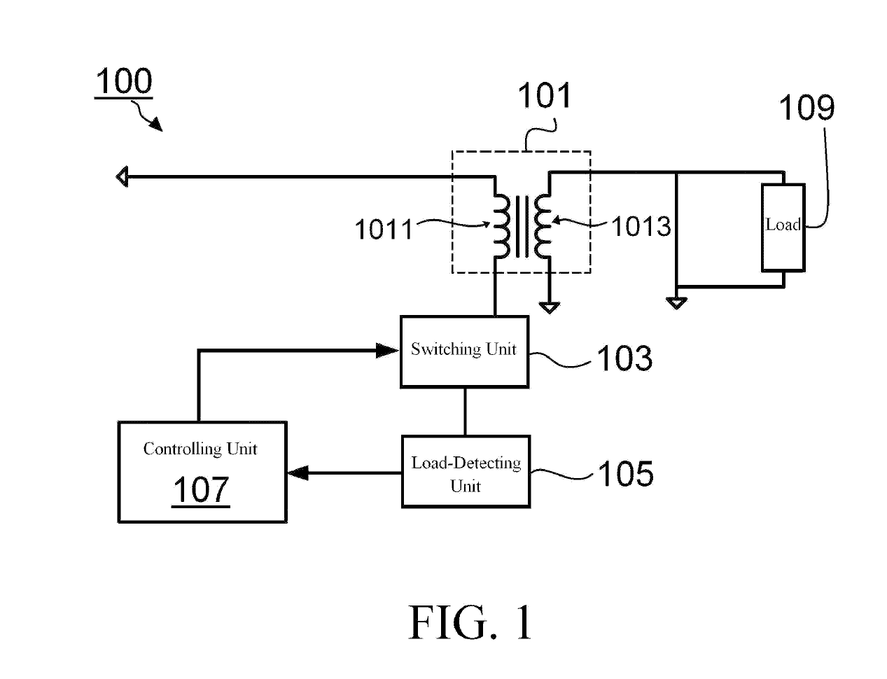

First, referring to FIG. 1, it illustrates a schematic diagram illustrating an embodiment of a controller with quasi-resonant mode and continuous conduction mode according to the present invention. The controller 100 comprises: a transformer 101, a switching unit 103, a load-detecting unit 105 and a load 109.

The transformer 101 includes a first winding 1011 and a secondary winding 1013. The load 109 couples to the secondary winding 1013, and the switching unit 103 is coupled electrically to the first winding 1011. Further, the load-detecting unit 105 is coupled electrically to the switching unit 103 and the controlling 107, and the controlling unit 107 is coupled electrically to the switching unit 103.

It's anticipated that the drawings only illustrates the important elements related to the present invention for clearly and briefly. Thus, some auxiliary elements or additional elements do not illustrate in those drawings. However, for person skilled in the art, they should understand those auxiliary elements or additional elements should be added into those drawings for performing those embodiments.

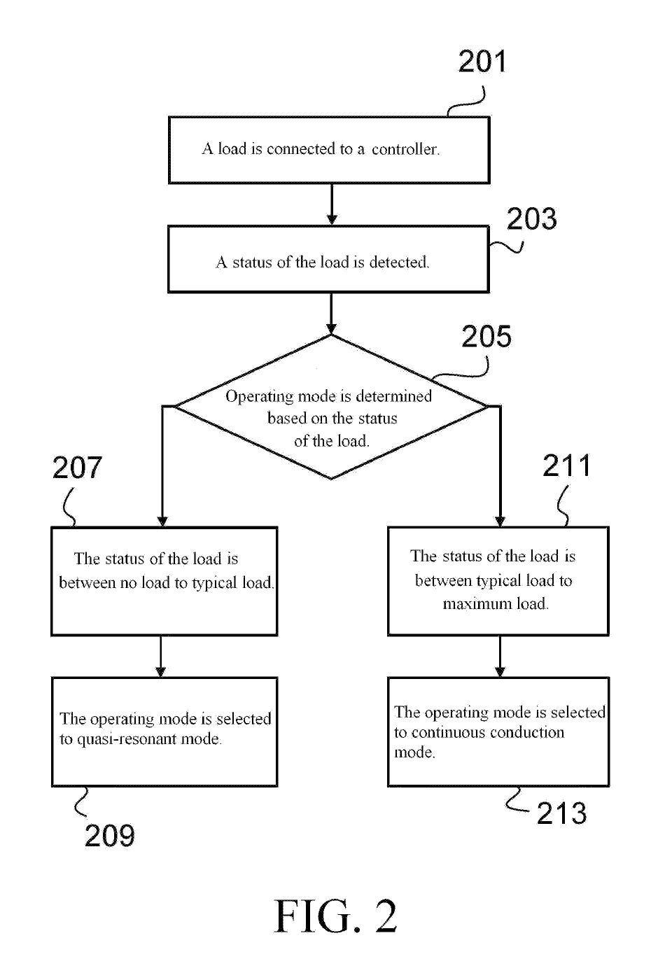

Referring to FIG. 2, it illustrates a flow chart of a method for operating method combining with quasi-resonant mode and continuous conduction mode according to the present invention.

At first, a load 109 is connected or coupled to a controller 100 (Step 201).

In the present invention, the load 109 would be any kinds of electrical products, such as cell phones or computers, which draw power from the controller with quasi-resonant mode and continuous conduction mode of the present invention. Thus, the level of the load 109 is not a constant value and is depending on the supplying power of various devices. Therefore, the level of the load 109 is changed with the different kinds of the electrical products. Moreover, even the same electrical products are charged, the level of the load 109 still will be altered by the different operating conditions. Therefore, the categories of the load 109 in the present invention are only used to describe but to limit.

Subsequently, a status of the load 109 is detected (Step 203). In this step, the status of the load 109, which is connected to the controller 100, is detected by the load-detecting unit 105.

The switching unit 103 is coupled electrically to the load-detecting unit 105, and the switching unit 103 is connected to the first winding 1011 of the transformer 101. Thus, the load-detecting unit 105 detects the status of the load 109 while the controller 100 is operating.

Furthermore, the load-detecting unit 105 is also coupled electrically to the controlling unit 107. Thus, the detected status of the load 109 from the load-detecting unit 105 is then transferred to the controlling unit 107.

In certain embodiments of the present invention, the controlling unit 107 is integrated circuit (IC) chip, but do not limit in this.

Further, the controlling unit 107 is determined whether the operating mode is used to the controller 100 based on the status (or level) of the load 109 (Step 205).

When the status or level of the load 109 is between no (zero) load and a typical (default) load (Step 207), the level of the load is defined as respective light load and controlling unit 107 switches the switching unit 103 in the quasi-resonant mode (Step 209). When the status or level of the load 109 is at between the typical (default) load and a maximum (uppermost) load (Step 211), the level of the load is defined as respective heavy load and the controlling unit 107 switches the switching unit 103 in the continuous conduction mode (Step 213). The default load is determined based on the transformer performance.

In this embodiment, the quasi-resonant mode is an operating mode, which is operated by both changing duty cycle and operation frequency; and the continuous conduction mode is an operating mode, which is operated by changing duty cycle and fixing frequency.

Therefore, the controller 100 detects the status of the load 109 via the load-detecting unit 105, and transfers the detected status or level to the controlling unit 107. Further, the controlling unit 107 switches the switching unit 103 in the quasi-resonant mode when the status of the load 109 is between no load and the typical (default) load for raising the level of the whole circuit. When the status of the load 109 is between the typical (default) load and the maximum load, the controlling unit 107 switches the switching unit 103 in the continuous conduction mode for reducing the pulse of current of the first winding 1011, and reducing the effect of the density of the magnetic flux in the magnetic core to raise the performance of the transformer 101.

For example, if the transformer 101 provides a typical (default) output power in the quasi-resonant mode, the transformer 101 having the same volume will provide higher power in the continuous conduction mode. Therefore, combining the quasi-resonant mode with the continuous conduction mode would upgrade the performance of the transformer 101 effectively.

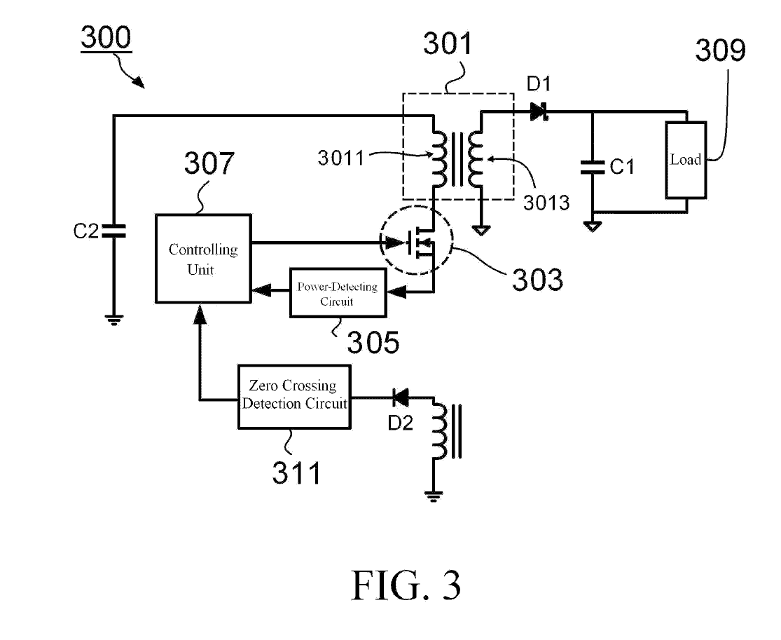

Subsequently, referring to FIG. 3, it illustrates a schematic diagram illustrating another embodiment of a controller with quasi-resonant mode and continuous conduction mode according to the present invention. In this embodiment, the controller 300 is applied in a flyback converter.

It's anticipated that some elements of the controller 300, which are the same as or similar with those in FIG. 1, will not describe again for briefly and clearly.

The controller 300 generally comprises a transformer 301, a field-effect transistor 303, a power-detecting circuit 305, a controlling 307, a load 309 and a zero crossing detection circuit 311.

In this case, the transformer 301 is the same as the transformer 101 in FIG. 1, and has a first winding 3011 and a secondary winding 3013. In this embodiment, the secondary winding 3013 is connected to a diode D1 and a capacitor C1 in series, and the load 309 is connected to the capacitor C1 in parallel.

Furthermore, one end of the first winding 3011 is coupled to the field-effect transistor 303, and another end of the first winding 3011 is coupled to a capacitor C2.

The field-effect transient 303 is a switching element, which is similar with the switching unit 103 illustrating in FIG. 1. In certain embodiments of the present invention, the field-effect transistor 303 is a metal-oxide-semiconductor field-effect transistor (MOSFET).

In addition, the power-detecting circuit 305 is an element, which is similar with the load-detecting unit 105 illustrating in FIG. 1. Thus, the power-detecting circuit 305 is utilized to detect power of the load 309. Moreover, the controlling unit 307 is a similar element as the controlling unit 107 illustrating in FIG. 1. Similarly, one end of the power-detecting circuit 305 is connected to the field-effect transistor 303, and another end of the power-detecting circuit 305 is connected to the controlling unit 307.

Furthermore, the detected power of the load 309 from the power detecting circuit 305 would transfer to the controlling unit 307, and the controlling unit 307 determines whether the detected power of the load 309 is between no load and a typical (default) load, or is between the typical (default) load and a maximum load. For example, the controlling unit 307 switches the field-effect transistor 303 to the quasi-resonant mode when the detected power of the load 309 is between no load and the typical load (on the other hand, the power-detecting circuit 305 detects a power lower than the power of the typical load). When the power-detecting circuit 305 detects a power which is lower than the power of the maximum load and higher than the power of the typical (default) load, the controlling unit 307 will switch the field-effect transistor 303 to the continuous conduction mode.

In addition, the zero crossing detection circuit 311 is coupled electrically to the controlling unit 307. In this case, the main function of the zero crossing detection circuit 311 is to detect a wave trough of the crossing voltage while the switcher is cut-off, and to conduct the switcher for reducing the energy loss of switching. In this embodiment, the zero crossing detection circuit 311 is used in the quasi-resonant mode. In the other word, the energy loss of switching will be reduced by switching the wave trough.

In this embodiment, the zero crossing detection circuit 311 is also connected electrically to a diode D2 and another first winding. However, it's anticipated that the foregoing elements, such as the diode D2 and another first winding, should be added, or cancelled depending on the practical requirements by any person skilled in the art, but it should be not limited in this.

Therefore, the controller 300 detects the power of the load 309 via the power-detecting circuit 305, and transfers the detected power to the controlling unit 307. Further, the controlling unit 307 switches the field-effect transistor 303 in the quasi-resonant mode when the power of the load 309 is between the power of no load and the typical (or default) load. In this quasi-resonant mode, the zero crossing detection circuit 311 is used to reduce energy loss of switching. When the power of the load 309 is between the power of the typical load and the maximum load, the controlling unit 307 switches the field-effect transistor 303 in the continuous conduction mode for reducing the pulse of current of the first winding 3011, and reducing the effect of the density of the magnetic flux in the magnetic core to raise the performance of the transformer 301.

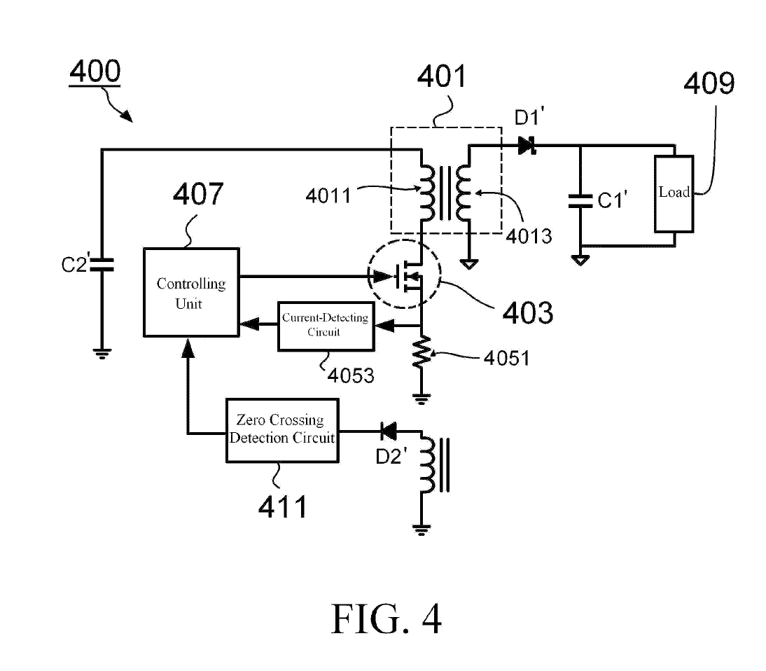

Subsequently, referring to FIG. 4, it illustrates a schematic diagram illustrating still another embodiment of a controller with quasi-resonant mode and continuous conduction mode according to the present invention. In this embodiment, some elements of controller 400, which are the same as, or similar with those elements of controller 300 illustrated in FIG. 3, would do not describe again for briefly and clearly. Only the differences between the two controllers are introduced.

In this embodiment, the controller 400 is applied to a flyback converter.

The controller 400 generally comprises a transformer 401, a field transistor 403, a resistor 4051, a current-detecting circuit 4053, a controlling unit 407, a load 409 and a zero crossing detection circuit 411.

In this case, the transformer 401 is the same as the transformer 101 illustrated in FIG. 1 and the transformer 301 illustrated in FIG. 3. The transformer 401 also has a first winding 4011 and a secondary winding 4013. In this embodiment, the controller 400 is the same as the controller 300 illustrated in FIG. 3, and the secondary winding 4013 is connected to a diode D1′ and a capacitor C1′ in series. Further, the load 409 is connected to capacitor C1′ in parallel.

Moreover, one end of the first winding 4011 is coupled to the field-effect transistor 403, and another end of the first winding 4011 is coupled to the capacitor C2′.

The field-effect transistor 403 is the same switching element as the field-effect transistor 303 illustrated in FIG. 3. In certain embodiments of the present invention, the filed-effect transistor 403 is MOSFET, but does not limit in this.

Therefore, in this embodiment, the current passing through the resistor 4051 is detected by the current-detecting circuit 4053 for obtaining the current condition of the load 409 (as the status of the load 409). Further, the current condition of the load 409 is transferred to the controlling unit 407. The controlling unit 407 determines whether the current condition is between those of no load and a typical load, or is between those of the typical load and a maximum load. Based on the result of the determination, the controller 400 is switched between the quasi-resonant mode and the continuous conduction mode by the field-effect transistor 403.

In this case, the controlling unit 407 is an element, which similar with the controlling unit 107 illustrated in FIG. 1 and the controlling unit 307 illustrated in FIG. 3. Therefore, the function of controlling unit 407 would not describe again for briefly and clearly.

In addition, the zero crossing detection circuit 411 is coupled electrically to the controlling unit 407. In the case, the zero crossing detection circuit 411 is the similar element as the zero crossing detection circuit 411 illustrated in FIG. 3. Therefore, the function of zero crossing detection circuit 411 would not describe again for briefly and clearly. Using the zero crossing detection circuit 411 in the quasi-resonant mode, the energy loss of switching in the switching element of the first side is reduced, and the energy loss of the switching in the rectifying elements of the second side is also reduced.

Similarly, in this embodiment, the zero crossing detection circuit 411 is also connected electrically to a diode D2′ and another first winding. However, it's anticipated that the foregoing elements, such as the diode D2′ and another first winding, should be added, or cancelled depending on the practical requirements by any person skilled in the art, but it should be not limited in this.

Therefore, the controller 400 detects the current of the load 409 via the resistor 4051 and the current-detecting circuit 4053, and transfers the detected power to the controlling unit 407. Further, the controlling unit 407 switches the field-effect transistor 403 in the quasi-resonant mode when the current of the load 409 is between the current of no load and the typical load. When the current of the load 409 is between the current of the typical load and the maximum load, the controlling unit 407 switches the field-effect transistor 403 in the continuous conduction mode for reducing the pulse of current of the first winding 4011, and reducing the effect of the density of the magnetic flux in the magnetic core to raise the performance of the transformer 401.

As mentioned-above, the present invention discloses the controller with quasi-resonant mode and continuous conduction mode and an operating method thereof. The controller has the both capability of the quasi-resonant mode and the continuous conduction mode. Further, the controller switches the operating modes between the quasi-resonant mode and the continuous conduction mode for raising the performance of the transformer in the continuous conduction mode, and for raising the efficiency of the whole circuit in the quasi-resonant mode. More particularly, the volume of the transformer in the controller of the present invention would be reduced effectively for reducing the volume of the controller of the present invention.

It will be understood that the above descriptions of embodiments are given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A controller with quasi-resonant mode and continuous conduction mode, comprising:
a transformer, including a first winding and a second winding, wherein the seconding winding connects to a load in parallel;
a switching unit, coupled electrically to the first winding;
a load-detecting unit, coupled electrically to said switching unit for detecting a status of the load; and
a controlling unit, coupled electrically between said switching unit and said load-detecting unit for switching said controller between a quasi-resonant mode and a continuous conduction mode based on the status of the load.

2. The controller according to the claim 1, wherein said switching unit is a field-effect transistor.

3. The controller according to the claim 2, wherein said field-effect transistor is a metal-oxide-semiconductor field-effect transistor (MOSFET)

4. The controller according to the claim 1, wherein the status of the load is current, and the load-detecting unit comprises:
a resistor, connecting to said switching unit in series; and
a current-detecting circuit, wherein one end of the current detecting circuit connecting between the resistor and said switching unit, and another end of the current detecting circuit connecting to said controlling unit.

5. The controller according to the claim 1, wherein the status of the load is power, and the load-detecting unit is a power-detecting circuit, wherein one end of the power-detecting circuit connects to said switching unit, and another end of the power-detecting circuit connects to said controlling unit.

6. The controller according to the claim 1, further comprising:
a zero crossing detection circuit, coupled electrically to said controlling unit.

7. The controller according to the claim 1, wherein said controlling unit is an integrated circuit (IC) chip.

8. The controller according to the claim 1, wherein said controller with quasi-resonant mode and continuous conduction mode is applied to a flyback converter.

9. An operating method of a controller with quasi-resonant mode and continuous conduction mode, the steps of the operating method comprising:
detecting a status of a load connected to said controller; and
switching operating modes of said controller between a quasi-resonant mode and a continuous conduction mode based on said status of the load.

10. The operating method according to the claim 9, wherein the operating mode of said controller is switched to quasi-resonant mode if said status of the load is between no load and a typical load; and the operating mode of said controller is switched to continuous conduction mode if said status of the load is between the typical load and a maximum load.

11. The operating method according to the claim 9, wherein the quasi-resonant mode is operated by both changing duty cycle and frequency; and the continuous conduction mode is operated by changing duty cycle and fixing frequency.
